(19) United States
(12) Patent Application Publication
(10) Pub. No.: US 2014/0299157 A1
(43) Pub. Date: Oct. 9, 2014

(54) Cleaning Method and Device for Ejection Head of Alignment Film Printer

(71) Applicant: SHENZHEN CHINA STAR OPTOELECTRONICS TECHNOLOGY CO., LTD., Shenzhen, Guangdong (CN)

(72) Inventor: Yu Song, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/807,364

(22) PCT Filed: Nov. 27, 2012
(86) PCT No.: PCT/CN2012/085370

§ 371 Date: Dec. 28, 2012

(30) Foreign Application Priority Data
Nov. 22, 2012 (CN) 201210477207.9

(51) Int. Cl. B41J 2/165

(52) U.S. Cl. CPC B41J 2/16517
USPC 134/18; 134/21; 134/95.2; 134/57 R; 134/99.1

(57) ABSTRACT

The present invention provides a cleaning method for an electing head of an alignment film printer, which is used automatically to clean up the ejection head of the alignment film printer, comprising the following steps: spraying a dissolving liquid to the ejection head of the alignment film printer at a specific time according to a specific moving path to dissolve droplets coagulated on the nozzles of the ejection head, and the dissolving liquid sprayed to cover all the ejection heads of the alignment film printer; proceeding with a vacuum suction according to the moving path to remove the dissolving liquid covered on the surface of the ejection head. The present invention further provides a cleaning device for an electing head of an alignment film printer. The cleaning method and device for the ejection head of the alignment film printer according to the present invention can prevent effectively the ejection head of the alignment film printer from clogging because of dry drip. It improves the printing quality of the alignment film printer and the product quality. Meanwhile, it can further increase the activation of the alignment film printer and decrease the cost of production.

This application claims priority to Chinese Patent Application Serial No. 201210477207.9, named as “cleaning method and device for ejection head of alignment film printer”, filed on Nov. 22, 2012, the specification of which is incorporated herein by reference.

### BACKGROUND OF THE INVENTION

1. Field of the Invention

The present invention relates to the field of alignment film printer techniques, and in particular to a cleaning method and device used to prevent the ejection head of the alignment film printer from clogging because of dry drip.

2. The Related Arts

At present, the alignment film printer has been widely applied to the coating process of the alignment film (Polyimide) of TFT-LCD. The principle is: the ejection head of the alignment film printer continuously sprays droplets with high speed and high density, which allows the droplets to fall on the surface of the substrate of the TFT array substrate or the CF color film and then level out to form a film through the diffusion effect of the surface tension. Specifically, intensive and small nozzles are distributed over the ejection head of the alignment film printer. Polyimide (PI) liquid is sprayed out from the nozzles on the ejection head by the deformation of the piezoelectric ceramic controlled by voltage, and the printing process is finished. The problems existed in the alignment film printer is as follows:
1. Because the nozzles on the ejection head are small, the nozzles will be clogged with dry drip of PI liquid when the alignment film printer is not working. Therefore, the clogged nozzles cannot spray the PI liquid when the alignment film printer works again, which will result the printing quality defects. Moreover, the substrate with defects should remove the PI film and be re-filmed, which delays the production time and wastes the PI liquid.
2. Meantime, when working again, it is needed to improve the clogged nozzles, which will waste the production time and the PI liquid and lower the activation of the alignment film printer.

Thus, it is desired to provide a cleaning method and device for ejection head of alignment film printer to dissolve the problems existed in the known technology.

### SUMMARY OF THE INVENTION

The technical issue to be solved by the present invention is to provide a cleaning method and device for ejection head of alignment film printer, which can prevent effectively the ejection head of the alignment film printer from clogging because of dry drip. It improves the printing quality of the alignment film printer and the product quality. Meanwhile, it can further increase the activation of the alignment film printer and decrease the cost of production.

To achieve the technical issue, the present invention provides a cleaning method for an ejection head of an alignment film printer, which is used automatically to clean up the ejection head of the alignment film printer, comprising the following steps: spraying a dissolving liquid to the ejection head of the alignment film printer at a specific time according to a specific moving path to dissolve droplets coagulated on the nozzles of the ejection head, and the dissolving liquid sprayed to cover all the ejection heads of the alignment film printer; proceeding with a vacuum suction according to the moving path to remove the dissolving liquid covered on the surface of the ejection head.

Wherein, the droplets are PI liquid; the dissolving liquid is N-methylpyrrolidone solvent.

Wherein, the step of spraying the dissolving liquid to the ejection head of the alignment film printer at a specific time according to a specific moving path alternates with the step of proceeding with the vacuum suction according to the moving path.

Wherein, the step of spraying dissolving liquid to the ejection head of the alignment film printer at a specific time according to a specific moving path comprises: switching on a first supply line to provide the dissolving liquid at a regular interval, and switching off the first supply line after spraying the dissolving liquid to cover all the ejection heads of the alignment film printer.

Wherein, the droplets are PI liquid; the dissolving liquid is N-methylpyrrolidone solvent.

Wherein, the step of switching on the first supply line to provide the dissolving liquid at a regular interval, and switching off the first supply line after spraying the dissolving liquid to cover all the ejection heads of the alignment film printer, alternates with the step of proceeding with the vacuum suction according to the moving path.

Wherein, the step of proceeding with the vacuum suction according to the moving path comprises: within a certain time of switching off the first supply line, switching on a second supply line with vacuum inside, the end of the second supply line connecting with a vacuum nozzle and removing the dissolving liquid on the surface of the ejection head through negative pressure thereof; switching off the second supply line after removing the dissolving liquid on the surface of the all ejection heads.

Wherein, the droplets are PI liquid; the dissolving liquid is N-methylpyrrolidone solvent.

Wherein, the step of switching on the first supply line to provide the dissolving liquid at a regular interval, and switching off the first supply line after spraying the dissolving liquid to cover all the ejection heads of the alignment film printer, alternates with the step of within a certain time of switching off the first supply line, switching on the second supply line with vacuum inside, the end of the second supply line connecting with the vacuum nozzle and removing the dissolving liquid on the surface of the ejection head through negative pressure thereof, and switching off the second supply line after removing the dissolving liquid on the surface of the all ejection heads.

To achieve the technical issue, the present invention provides a cleaning device for an ejection head of an alignment film printer, which is used automatically to clean up the ejection head of the alignment film printer, comprising: a cleaning ejection head, which is provided under the ejection head of the alignment film printer, used to spray a dissolving liquid to the ejection head of the alignment film printer at a specific time according to a specific moving path to dissolve droplets coagulated on the nozzles of the ejection head, and the dissolving liquid sprayed to cover all the ejection heads of the alignment film printer; a vacuum nozzle, which is provided under the ejection head of the alignment film printer, used to proceed with a vacuum suction according to the moving path to remove the dissolving liquid covered on the surface of the ejection head; the cleaning ejection head connecting with the vacuum nozzle, which is provided as multiple groups; the cleaning ejection head alternating with the vacuum nozzle according to the moving path.

Wherein, it further comprises: a first supply line, which connects with the cleaning eject head to supply the dissolving liquid; a second supply line, which connects with the vacuum nozzle to form vacuum inside; wherein, the first supply line and the second supply line are provided with a solenoid valve respectively.

Wherein, it further comprises a PLC controller connecting with the solenoid valve of the first supply line; wherein the PLC controller switches on the solenoid valve of the first supply line at a regular interval, and switching off the solenoid valve of the first supply line after spraying the dissolving liquid to cover all the ejection heads of the alignment film printer.

Wherein, the PLC controller further connects with the solenoid valve of the second supply line; the PLC controller switches on the solenoid valve of the second supply line after switching off the solenoid valve of the first supply line, the vacuum nozzle removes the dissolving liquid on the surface of the ejection head through negative pressure within the second supply line.

To achieve the technical issue, the present invention further provides a cleaning device for an ejection head of an alignment film printer, which is used automatically to clean up the ejection head of the alignment film printer, comprising: a cleaning ejection head, which is provided under the ejection head of the alignment film printer, used to spray a dissolving liquid to the ejection head of the alignment film printer at a specific time according to a specific moving path to dissolve droplets coagulated on the nozzles of the ejection head, and the dissolving liquid sprayed to cover all the ejection heads of the alignment film printer; a vacuum nozzle, which is provided under the ejection head of the alignment film printer, used to proceed with a vacuum suction according to the moving path to remove the dissolving liquid covered on the surface of the ejection head.

Wherein, it further comprises: a first supply line, which connects with the cleaning eject head to supply the dissolving liquid; a second supply line, which connects with the vacuum nozzle to form vacuum inside; wherein, the first supply line and the second supply line are provided with a solenoid valve respectively.

Wherein, it further comprises a PLC controller connecting with the solenoid valve of the first supply line; wherein, the PLC controller switches on the solenoid valve of the first supply line at a regular interval, and switching off the solenoid valve of the first supply line after spraying the dissolving liquid to cover all the ejection heads of the alignment film printer.

Wherein, the PLC controller further connects with the solenoid valve of the second supply line; the PLC controller switches on the solenoid valve of the second supply line after switching off the solenoid valve of the first supply line, the vacuum nozzle removes the dissolving liquid on the surface of the ejection head through negative pressure within the second supply line.

Wherein, the cleaning ejection head connects with the vacuum nozzle, which is provided as multiple groups.

Wherein, the cleaning ejection head alternates with the vacuum nozzle according to the moving path.

The cleaning method and device for ejection head of alignment film printer according to the present invention has the beneficial effects as follow. Dissolve the coagulated PI liquid by spraying the dissolving liquid to the ejection head, and further clean the ejection head by proceeding with a vacuum suction or dissolving to remove the residual PI liquid, which can prevent effectively the ejection head of the alignment film printer from clogging because of dry drip. It improves the printing quality of the alignment film printer and the product quality. Meanwhile, it can further increase the activation of the alignment film printer and decrease the cost of production.

### BRIEF DESCRIPTION OF THE DRAWINGS

FIG. 1 is a flow chart of the cleaning method for the ejection head of the alignment film printer according to the embodiment of the present invention;

FIG. 2 is a specific flow chart of the cleaning method for the ejection head of the alignment film printer according to the embodiment of the present invention;

FIG. 3 is a schematic view illustrating the structure of the cleaning device for the ejection head of the alignment film printer according to the embodiment of the present invention;

FIG. 4 is a schematic view illustrating the distribution of the cleaning ejection head and the vacuum nozzle of the cleaning device for the ejection head of the alignment film printer according to the embodiment of the present invention;

FIG. 5 is a schematic plane that the cleaning device for the ejection head of the alignment film printer according to the embodiment of the present invention cleans the ejection head; and

FIG. 6 is a schematic plane illustrating the moving path of the cleaning ejection head and the vacuum nozzle of the cleaning device for the ejection head of the alignment film printer according to the embodiment of the present invention.

### DETAILED DESCRIPTION OF THE PREFERRED EMBODIMENTS

The detailed descriptions accompanying drawings and the embodiment of the present invention are as follows.

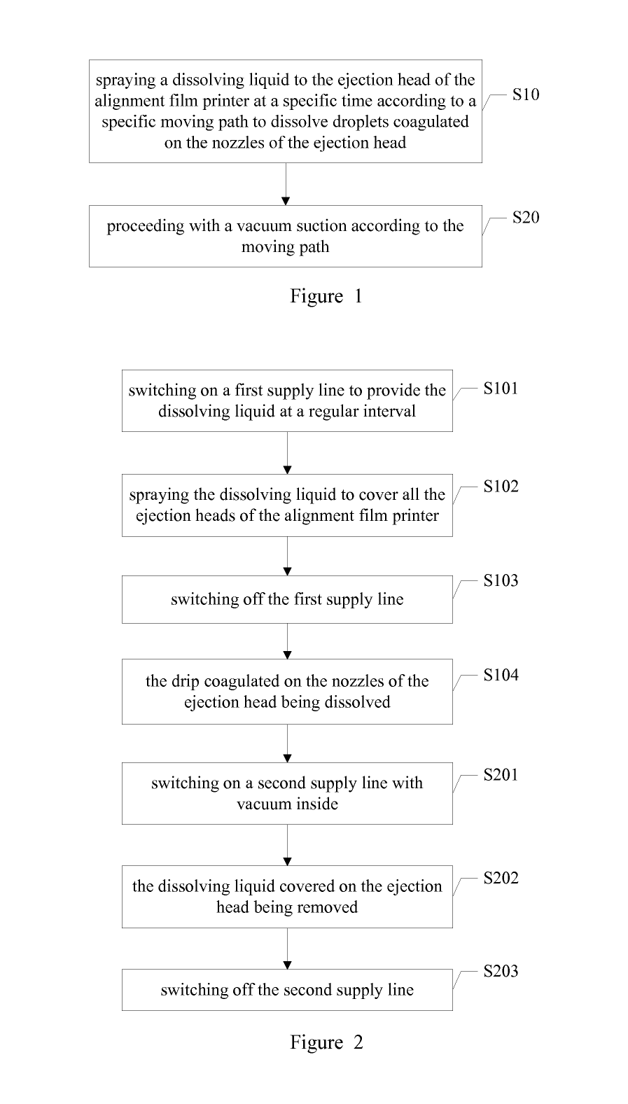

Referring to FIG. 1, a cleaning method for an ejection head of an alignment film printer according to the embodiment of the present invention comprises the following steps.

Step S10, spray a dissolving liquid to the ejection head of the alignment film printer at a specific time according to a specific moving path to dissolve droplets coagulated on the nozzles of the ejection head, and the dissolving liquid is sprayed to cover all the ejection heads of the alignment film printer.

Step S20, proceed with a vacuum suction according to the moving path to remove the dissolving liquid covered on the surface of the ejection head.

Wherein, the droplets sprayed from the nozzles of the ejection head of the alignment film printer are PI liquid, and the PI liquid is easy to dry or coagulate to clog up the ejection head. The purpose of spraying dissolving liquid is to dissolve the dried or coagulated PI liquid. In the present embodiment, the dissolving liquid is N-methylpyrrolidone solvent, which is the main component of the solvent in the PI liquid, so that it can dissolve the dried or coagulated PI liquid. If the ejection head of the alignment film printer sprays the other liquid, the corresponding dissolving liquid can be used, which can prevent or remove the clogging of the ejection head.

Referring to FIG. 2, it is a specific flow chart of the cleaning method for the ejection head of the alignment film printer according to the embodiment of the present invention. Step S10 comprises the following steps.

Step S101, switch on a first supply line to provide the dissolving liquid at a regular interval. Specifically, the regular interval means the time between spraying the dissolving liquid twice, which can be decided according to the actual situation. It can refer to the period of drip drying and the dissolving time of the dry drip. Cyclic control can realize fully automated cleaning process, which saves the labor cost and the maintenance cost of the equipment.

Step S102, spray the dissolving liquid to cover all the ejection heads of the alignment film printer according to the specific moving path. The moving path can be provided according to the actual situation, which allows the spraying range of the dissolving liquid can cover all the ejection heads of the alignment film printer and improves the cleaning effects.

In the present embodiment, when spraying according to the specific moving path, the spraying range of the dissolving liquid can cover all the ejection heads. For example, the moving path is rectangular or circular shape. Providing the specific moving path facilitates to spray back and forth and full coverage.

Step S103, switch off the first supply line. After spraying according to the above moving path, switch off the supply line and go to step S104, the dissolving liquid dissolves the PI liquid on the ejection head.

Step S20 comprises the following steps.

Step S201, within a certain time of switching off the first supply line, switch on a second supply line with vacuum inside, the end of the second supply line connects with a vacuum nozzle and removes the dissolving liquid on the surface of the ejection head through negative pressure thereof. By effectively controlling the time of the step, it can save the dissolving liquid and improve the cleaning effects. Specifically, the PLC device can be used to control the time.

Step S202, proceed with a vacuum suction according to the moving path to remove the PI liquid, dissolving liquid or reaction liquid covered on the surface, which can clean the ejection head of the alignment film printer deeply. Specifically, the vacuum suction also moves according to the moving path mention above. In the present invention, the moving path of the vacuum suction is the same as that of spraying the dissolving liquid. The residual PI liquid, dissolving liquid or reaction liquid on the surface of the all ejection heads can be removed through negative pressure in the second supply line.

After finishing the step S202, go to the step S203, switch off the second supply line.

Wherein, by this cleaning method, it can increase the activation of the alignment film printer. The saved cost is estimated as follows. For example, without using the above cleaning method, each alignment film printer will be clogged three times everyday because of the PI liquid drying. Each time cleaning the ejection head needs 0.5 hour, and about 500 g PI liquid is wasted.

Assuming the price of the PI liquid is four dollars per gram, and it needs four alignment film printers working at the same time during mass production. On this basis, it can improve 2190 hours of the activation time of the alignment film printer every year, and the calculation formula is 3*4*0.5*365; it can save about twenty million dollars of the cost of the PI liquid every year, and the calculation formula is 3*4*500*4*365.

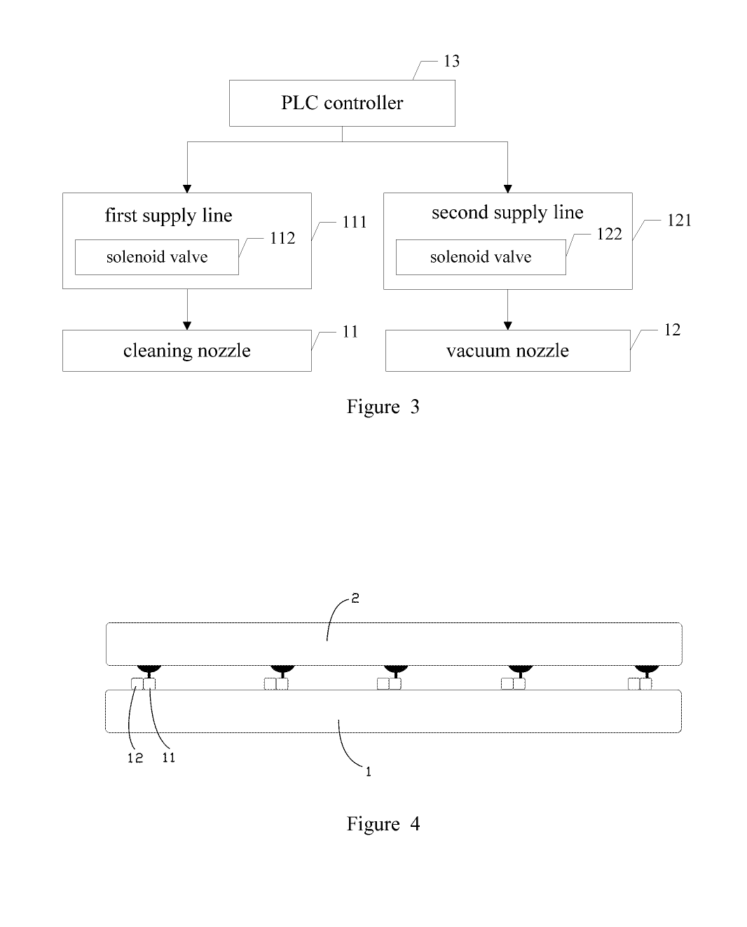

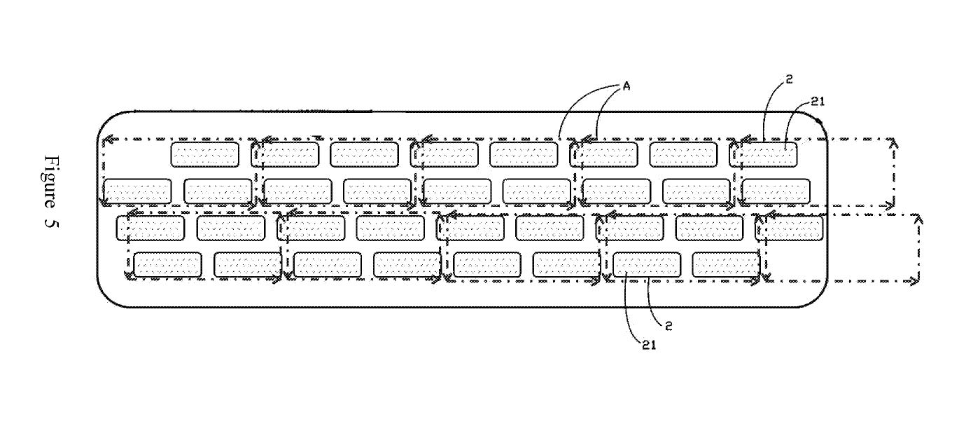

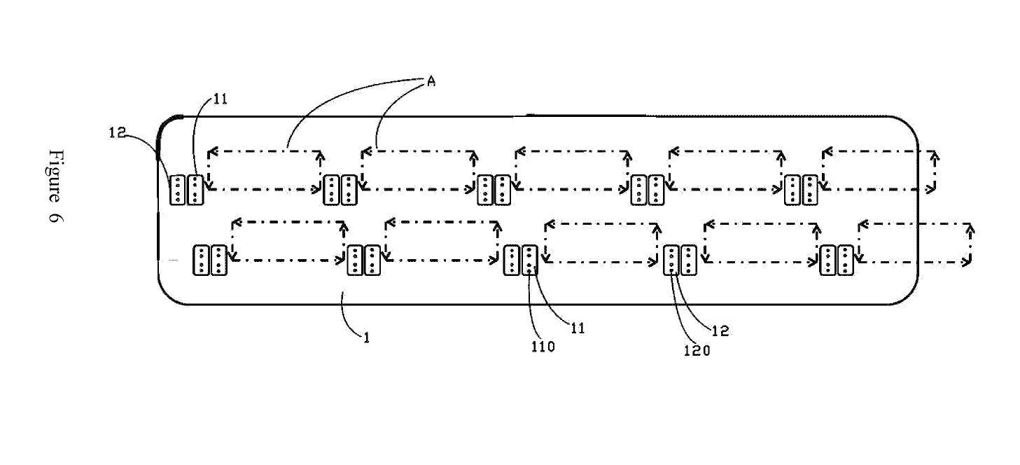

The present invention further provides a cleaning device for an ejection head of an alignment film printer, which is used automatically to clean up the ejection head of the alignment film printer. Referring to FIG. 3, it is a schematic view illustrating the structure of the cleaning device for the ejection head of the alignment film printer according to the embodiment of the present invention, which comprises: a cleaning ejection head 11, which is provided under the ejection head 2 of the alignment film printer (as shown in FIG. 4). The ejection head 2 according to the present invention is provided as multiple and arranged regularly. Referring to FIG. 5, it is a schematic plane that the cleaning device for the ejection head of the alignment film printer according to the embodiment of the present invention cleans the ejection head. The ejection head 2 used to spray the PI liquid is provided as four rows and staggered in a certain angle. Each ejection head 2 is provided with multiple nozzles 21.

The cleaning ejection head 11 is provided as multiple, which is arranged as upper and lower rows in the present embodiment and totally is ten. There is a certain distance between the two adjacent cleaning ejection heads 11.

The cleaning ejection head 11 sprays the dissolving liquid to the ejection head 2 of the alignment film printer at a specific time according to a specific moving path A to dissolve droplets coagulated on the ejection head 2. Wherein, the droplets sprayed from the nozzles of the ejection head of the alignment film printer are PI liquid, and the PI liquid is easy to dry or coagulate to clog up the ejection head. The purpose of spraying dissolving liquid is to dissolve the dried or coagulated PI liquid. In the present embodiment, the dissolving liquid is N-methylpyrrolidone solvent, which is the main component of the solvent in the PI liquid, so that it can dissolve the dried or coagulated PI liquid. If the ejection head of the alignment film printer sprays the other liquid, the corresponding dissolving liquid can be used, which can prevent or remove the clogging of the ejection head.

Furthermore, the cleaning device comprises a first supply line 111, which connects with the cleaning eject head to supply the dissolving liquid. The first supply line 111 is provided with a solenoid valve 112. The solenoid valve 112 is connected with a PLC controller 13.

Wherein, the PLC controller 13 switches on the solenoid valve 112 of the first supply line 111 at a regular interval. Meantime, each cleaning ejection head 11 can move according to the rectangular moving path A as shown in FIGS. 5 and 6, on which is provided with multiple spraying points 110. The spraying points 110 can spray the dissolving liquid to the moving path A and the adjacent area. Wherein, the moving path A refers to the entire trajectory of the cleaning nozzle 11, which can be provided according to the actual situation. It allows the spraying range of the spraying points 110 of the dissolving liquid can cover all the ejection heads of the alignment film printer and improves the cleaning effects.

In the present embodiment, when the ten cleaning ejection heads 11 shown in FIG. 5 move counterclockwise a cycle, the sprayed dissolving liquid can cover all the ejection heads 2 of the alignment film printer. After spraying, the PLC controller 13 switches off the solenoid valve 112 of the first supply line 111. The dissolving liquid dissolves the PI liquid coagulated on the ejection heads.

The cleaning device further comprises: a vacuum nozzle 12, which is provided under the ejection head 2 of the alignment film printer. The vacuum nozzle 12 according to the present embodiment is stuck with the cleaning ejection head 11, which can move according to the moving path A under the same device. The structure is simple and the utilization rate can be increased.

In the present embodiment, the moving path of the vacuum nozzle 12 is the same as the moving path A of the cleaning ejection head 11, which can remove the residual PI liquid, dissolving liquid or reaction liquid on the surface of the all ejection heads.

Furthermore, the cleaning device comprises a second supply line 121, which connects with the vacuum nozzle 12 to supply the dissolving liquid. The second supply line 121 is provided with a solenoid valve 122. The solenoid valve 122 is connected with the PLC controller 13.

Wherein, the PLC controller 13 switches off the solenoid valve 112 of the first supply line 111 at a regular interval and switches on the solenoid valve 122 of the second supply line 121. The vacuum nozzle 12 connected with the end of the second supply line 121 removes the dissolving liquid on the surface of the ejection head 2 through negative pressure thereof. Meantime, each vacuum nozzle 12 can move according to the rectangular moving path A as shown in FIGS. 5 and 6, on which is provided with multiple suction holes 120. The suction holes 120 can remove the residual liquid on the moving path A and the adjacent area. After the vacuum nozzle 12 removes all liquids on the surface of the ejection head 2, the PLC controller 13 switches off the solenoid valve 122 of the second supply line 121.

In a preferred embodiment, the time of the PLC controller 13 switching on the solenoid valve 112 of the first supply line 111 alternates with that of the PLC controller 13 switching on the solenoid valve 122 of the second supply line 121. That is, spraying the dissolving liquid alternates with the vacuum suction, which provides more sufficient cleaning time.

The cleaning device according to the present invention increases the activation of the alignment film printer. The saved cost is estimated as follows: without using the above cleaning method, each alignment film printer will be clogged three times everyday because of the PI liquid drying. Each time cleaning the ejection head needs 0.5 hour, and about 500 g PI liquid is wasted.

Assuming the price of the PI liquid is four dollars per gram, and it needs four alignment film printers working at the same time during mass production. On this basis, it can improve 2190 hours of the activation time of the alignment film printer every year, and the calculation formula is 3*4*0.5*365; it can save about twenty million dollars of the cost of the PI liquid every year, and the calculation formula is 3*4*500*4*365.

The cleaning method and device for ejection head of alignment film printer according to the present invention has the beneficial effects as follows. Dissolve the coagulated PI liquid by spraying the dissolving liquid to the ejection head, and further clean the ejection head by proceeding with a vacuum suction or dissolving to remove the residual PI liquid, which can prevent effectively the ejection head of the alignment film printer from clogging because of dry drip. It improves the printing quality of the alignment film printer and the product quality. Meanwhile, it can further increase the activation of the alignment film printer and decrease the cost of production.

The preferred embodiments according to the present invention are mentioned above, which cannot be used to define the scope of the right of the present invention. Those modifications and variations are considered encompassed in the scope of protection defined by the clams of the present invention.

What is claimed is:

1. A cleaning method for an ejection head of an alignment film printer, which is used automatically to clean up the ejection head of the alignment film printer, comprising the following steps:
spraying a dissolving liquid to the ejection head of the alignment film printer at a specific time according to a specific moving path to dissolve droplets coagulated on the nozzles of the ejection head, and the dissolving liquid sprayed to cover all the ejection heads of the alignment film printer;
proceeding with a vacuum suction according to the moving path to remove the dissolving liquid covered on the surface of the ejection head.

2. The cleaning method for an ejection head of an alignment film printer as claimed in claim 1, wherein the droplets are PI liquid; the dissolving liquid is N-methylpyrrolidone solvent.

3. The cleaning method for an ejection head of an alignment film printer as claimed in claim 2, wherein the step of spraying the dissolving liquid to the ejection head of the alignment film printer at a specific time according to a specific moving path alternates with the step of proceeding with the vacuum suction according to the moving path.

4. The cleaning method for an ejection head of an alignment film printer as claimed in claim 1, wherein the step of spraying dissolving liquid to the ejection head of the alignment film printer at a specific time according to a specific moving path comprises:
switching on a first supply line to provide the dissolving liquid at a regular interval, and switching off the first supply line after spraying the dissolving liquid to cover all the ejection heads of the alignment film printer.

5. The cleaning method for an ejection head of an alignment film printer as claimed in claim 4, wherein the droplets are PI liquid; the dissolving liquid is N-methylpyrrolidone solvent.

6. The cleaning method for an ejection head of an alignment film printer as claimed in claim 4, wherein the step of switching on the first supply line to provide the dissolving liquid at a regular interval, and switching off the first supply line after spraying the dissolving liquid to cover all the ejection heads of the alignment film printer, alternates with the step of proceeding with the vacuum suction according to the moving path.

7. The cleaning method for an ejection head of an alignment film printer as claimed in claim 4, wherein the step of proceeding with the vacuum suction according to the moving path comprises:
within a certain time of switching off the first supply line, switching on a second supply line with vacuum inside, the end of the second supply line connecting with a vacuum nozzle and removing the dissolving liquid on the surface of the ejection head through negative pressure thereof;
switching off the second supply line after removing the dissolving liquid on the surface of the all ejection heads.

8. The cleaning method for an ejection head of an alignment film printer as claimed in claim 7, wherein the droplets are PI liquid; the dissolving liquid is N-methylpyrrolidone solvent.

9. The cleaning method for an ejection head of an alignment film printer as claimed in claim 7, wherein the step of switching on the first supply line to provide the dissolving liquid at a regular interval, and switching off the first supply line after spraying the dissolving liquid to cover all the ejection heads of the alignment film printer, alternates with the step of within a certain time of switching off the first supply line, switching on the second supply line with vacuum inside, the end of the second supply line connecting with the vacuum nozzle and removing the dissolving liquid on the surface of the ejection head through negative pressure thereof, and switching off the second supply line after removing the dissolving liquid on the surface of the all ejection heads.

10. A cleaning device for an ejection head of an alignment film printer, which is used automatically to clean up the ejection head of the alignment film printer, comprising:
a cleaning ejection head, which is provided under the ejection head of the alignment film printer, used to spray a dissolving liquid to the ejection head of the alignment film printer at a specific time according to a specific moving path to dissolve droplets coagulated on the nozzles of the ejection head, and the dissolving liquid sprayed to cover all the ejection heads of the alignment film printer;
a vacuum nozzle, which is provided under the ejection head of the alignment film printer, used to proceed with a vacuum suction according to the moving path to remove the dissolving liquid covered on the surface of the ejection head;
the cleaning ejection head connecting with the vacuum nozzle, which is provided as multiple groups;
the cleaning ejection head alternating with the vacuum nozzle according to the moving path.

11. The cleaning device for an ejection head of an alignment film printer as claimed in claim 10, wherein it further comprises:
a first supply line, which connects with the cleaning eject head to supply the dissolving liquid;
a second supply line, which connects with the vacuum nozzle to form vacuum inside;
wherein, the first supply line and the second supply line are provided with a solenoid valve respectively.

12. The cleaning device for an ejection head of an alignment film printer as claimed in claim 11, wherein it further comprises a PLC controller connecting with the solenoid valve of the first supply line;
wherein, the PLC controller switches on the solenoid valve of the first supply line at a regular interval, and switching off the solenoid valve of the first supply line after spraying the dissolving liquid to cover all the ejection heads of the alignment film printer.

13. The cleaning device for an ejection head of an alignment film printer as claimed in claim 12, wherein the PLC controller further connects with the solenoid valve of the second supply line; the PLC controller switches on the solenoid valve of the second supply line after switching off the solenoid valve of the first supply line, the vacuum nozzle removes the dissolving liquid on the surface of the ejection head through negative pressure within the second supply line.

14. A cleaning device for an ejection head of an alignment film printer, which is used automatically to clean up the ejection head of the alignment film printer, comprising:
a cleaning ejection head, which is provided under the ejection head of the alignment film printer, used to spray a dissolving liquid to the ejection head of the alignment film printer at a specific time according to a specific moving path to dissolve droplets coagulated on the nozzles of the ejection head, and the dissolving liquid sprayed to cover all the ejection heads of the alignment film printer;
a vacuum nozzle, which is provided under the ejection head of the alignment film printer, used to proceed with a vacuum suction according to the moving path to remove the dissolving liquid covered on the surface of the ejection head.

15. The cleaning device for an ejection head of an alignment film printer as claimed in claim 14, wherein it further comprises:
a first supply line, which connects with the cleaning eject head to supply the dissolving liquid;
a second supply line, which connects with the vacuum nozzle to form vacuum inside;
wherein, the first supply line and the second supply line are provided with a solenoid valve respectively.

16. The cleaning device for an ejection head of an alignment film printer as claimed in claim 15, wherein it further comprises a PLC controller connecting with the solenoid valve of the first supply line;
wherein, the PLC controller switches on the solenoid valve of the first supply line at a regular interval, and switching off the solenoid valve of the first supply line after spraying the dissolving liquid to cover all the ejection heads of the alignment film printer.

17. The cleaning device for an ejection head of an alignment film printer as claimed in claim 16, wherein the PLC controller further connects with the solenoid valve of the second supply line; the PLC controller switches on the solenoid valve of the second supply line after switching off the solenoid valve of the first supply line, the vacuum nozzle removes the dissolving liquid on the surface of the ejection head through negative pressure within the second supply line.

18. The cleaning device for an ejection head of an alignment film printer as claimed in claim 17, wherein the cleaning ejection head connects with the vacuum nozzle, which is provided as multiple groups.

19. The cleaning device for an ejection head of an alignment film printer as claimed in claim 17, wherein the cleaning ejection head alternates with the vacuum nozzle according to the moving path.
